(19) United States
(12) Patent Application Publication
(10) Pub. No.: US 2026/0214013 A1
(43) Pub. Date: Jul. 23, 2026

(54) DATA SYNCHRONIZATION AND DATA ONBOARDING PROTOCOL USING DIGITAL TWINS IN A DISTRIBUTED NETWORK

(71) Applicant: BANK OF AMERICA CORPORATION, Charlotte, NC (US)

(72) Inventors: Thomas Rosetti, Charlotte, NC (US); Todd Deegan, Concord, NC (US); Kaitlyn Jones, Charlotte, NC (US); Mohamed Faris Khaleeli, Charlotte, NC (US); Adam King, Fort Mill, SC (US); Sanjay Lohar, Mint Hill, NC (US); Khizzar Tajak, Charlotte, NC (US); Michael R. Young, Davidson, NC (US)

(73) Assignee: BANK OF AMERICA CORPORATION, Charlotte, NC (US)

(21) Appl. No.: 19/033,654

(22) Filed: Jan. 22, 2025

(51) Int. Cl. H04L 41/14; H04L 41/16; H04L 67/02

(52) U.S. Cl. CPC H04L 41/145; H04L 41/16; H04L 67/02

(57) ABSTRACT

Systems, computer program products, and methods are described herein for data synchronization and data onboarding protocol using digital twins in a distributed network. The present disclosure includes receiving onboarding data for a user, identifying onboarding tasks using a machine learning model, generating, using the first machine learning model, a task workflow of the onboarding tasks, receiving a stream of task completion data, logging completion of the onboarding tasks in the task workflow, receiving, in a second machine learning model, a stream of interaction data of the user, determining, using the second machine learning model, a presence or an absence of at least one malfeasance indicator by determining at least one malfeasance score based on the interaction data, and generating a digital twin of the user using the interaction data.

### TECHNOLOGICAL FIELD

Example implementations of the present disclosure relate to a system and method for data synchronization and data onboarding protocol using digital twins in a distributed network.

### BACKGROUND

Entities often encounter inefficiencies in their onboarding processes due to excessive manual oversight and management, particularly in areas related to security reviews and compliance requirements. These procedures, while important for maintaining operational integrity, can inadvertently delay or reject qualified applicants due to rigid rule-based systems and bottlenecks created by sequential case handling, which can result in false attribution of malfeasance to the onboarded party that hinders the onboarding process. Such delays not only result in missed opportunities to onboard legitimate users but also hinder the entity's ability to improve potential outcomes. Existing strategies for managing and ensuring compliance for onboarding typically rely on predefined rules and static historical data, which, while effective in certain scenarios, fail to adapt dynamically to evolving malfeasance tactics or account for nuanced behavior. Consequently, the onboarding process remains a significant challenge, lacking efficiency and flexibility, and necessitates a solution that mitigates delays, minimizes false positives, and improves the overall experience for all stakeholders. Accordingly, there exists a need for systems and methods for data synchronization and data onboarding protocol using digital twins in a distributed network.

### BRIEF SUMMARY

Systems, methods, and computer program products are provided for data synchronization and data onboarding protocol using digital twins in a distributed network.

In one aspect, a system for data synchronization and data onboarding protocol using digital twins in a distributed network is presented. The system may include a processing device, and a non-transitory storage device containing instructions, when executed by the processing device, the instructions cause the processing device to perform the steps of receiving onboarding data for a user, where the onboarding data is received through an API or web-based interface, identifying, based on the onboarding data and using a first machine learning model including natural language processing, onboarding tasks, generating, using the first machine learning model, a task workflow of the onboarding tasks, receiving a stream of task completion data for the onboarding tasks of the task workflow, logging completion of the onboarding tasks in the task workflow, receiving, in a second machine learning model, a stream of interaction data of the user, where the interaction data is at least one selected from the group consisting of resource transfer data, geolocation data, and endpoint device usage patterns, determining, using the second machine learning model, a presence or an absence of at least one malfeasance indicator by determining at least one malfeasance score based on the interaction data and comparing the at least one malfeasance score with predetermined malfeasance indicator thresholds, and generating a digital twin of the user using the interaction data, where the digital twin generates simulated user activities via a digital representation.

In some implementations, the instructions further cause the processing device to perform the steps of recording, in a distributed ledger, the presence or absence of the at least one malfeasance indicator.

In some implementations, the digital twin may include a data integration module operatively coupled to real-time data sources, the real-time data sources including resource transfer gateways, the data integration module continuously updating the digital representation with the real-time data sources, a predictive analytics engine configured to generate the simulated user activities based on historical and real-time data, and an onboarding criteria adjustment module, operatively coupled to the predictive analytics engine, configured to dynamically recalibrate the predetermined malfeasance indicator thresholds in response to the simulated user activities.

In some implementations, the task workflow may include critical dates for the onboarding tasks, and the instructions further cause the processing device to perform the steps of monitoring the completion of the onboarding tasks relative the critical dates, and generating an alert signal upon a first condition where at least one onboarding task is not completed relative a corresponding critical date.

In some implementations, the onboarding data is at least one selected from the group consisting of user identification data, user ledger data, and compliance data.

In some implementations, onboarding tasks are at least one selected from the group consisting of document submission, compliance verification, and identity verification.

In some implementations, the first machine learning model and the second machine learning model are the same machine learning model.

In another aspect, a computer program product for data synchronization and data onboarding protocol using digital twins in a distributed network is presented. The computer program product may include a non-transitory computer-readable medium including code causing an apparatus to receive onboarding data for a user, where the onboarding data is received through an API or web-based interface, identify, based on the onboarding data and using a first machine learning model including natural language processing, onboarding tasks, generate, using the first machine learning model, a task workflow of the onboarding tasks, receive a stream of task completion data for the onboarding tasks of the task workflow, log completion of the onboarding tasks in the task workflow, receive, in a second machine learning model, a stream of interaction data of the user, where the interaction data is at least one selected from the group consisting of resource transfer data, geolocation data, and endpoint device usage patterns, determine, using the second machine learning model, a presence or an absence of at least one malfeasance indicator by determining at least one malfeasance score based on the interaction data and comparing the at least one malfeasance score with predetermined malfeasance indicator thresholds, and generate a digital twin of the user using the interaction data, where the digital twin generates simulated user activities via a digital representation.

In some implementations, the code further causes the apparatus to record, in a distributed ledger, the presence or absence of the at least one malfeasance indicator.

In some implementations, the digital twin may include a data integration module operatively coupled to real-time data sources, the real-time data sources including resource transfer gateways, the data integration module continuously updating the digital representation with the real-time data sources, a predictive analytics engine configured to generate the simulated user activities based on historical and real-time data, and an onboarding criteria adjustment module, operatively coupled to the predictive analytics engine, configured to dynamically recalibrate the predetermined malfeasance indicator thresholds in response to the simulated user activities.

In some implementations, the task workflow may include critical dates for the onboarding tasks, and the code further causes the apparatus to monitor the completion of the onboarding tasks relative the critical dates and generate an alert signal upon a first condition where at least one onboarding task is not completed relative a corresponding critical date.

In some implementations, the onboarding data is at least one selected from the group consisting of user identification data, user ledger data, and compliance data.

In some implementations, the onboarding tasks are at least one selected from the group consisting of document submission, compliance verification, and identity verification.

In some implementations, the first machine learning model and the second machine learning model are the same machine learning model.

In yet another aspect, a method for data synchronization and data onboarding protocol using digital twins in a distributed network is presented. The method may include receiving onboarding data for a user, where the onboarding data is received through an API or web-based interface, identifying, based on the onboarding data and using a first machine learning model including natural language processing, onboarding tasks, generating, using the first machine learning model, a task workflow of the onboarding tasks, receiving a stream of task completion data for the onboarding tasks of the task workflow, logging completion of the onboarding tasks in the task workflow, receiving, in a second machine learning model, a stream of interaction data of the user, where the interaction data is at least one selected from the group consisting of resource transfer data, geolocation data, and endpoint device usage patterns, determining, using the second machine learning model, a presence or an absence of at least one malfeasance indicator by determining at least one malfeasance score based on the interaction data and comparing the at least one malfeasance score with predetermined malfeasance indicator thresholds, and generating a digital twin of the user using the interaction data, where the digital twin generates simulated user activities via a digital representation.

In some implementations, the method may further include recording, in a distributed ledger, the presence or absence of the at least one malfeasance indicator.

In some implementations, the digital twin may include a data integration module operatively coupled to real-time data sources, the real-time data sources including resource transfer gateways, the data integration module continuously updating the digital representation with the real-time data sources, a predictive analytics engine configured to generate the simulated user activities based on historical and real-time data, and an onboarding criteria adjustment module, operatively coupled to the predictive analytics engine, configured to dynamically recalibrate the predetermined malfeasance indicator thresholds in response to the simulated user activities.

In some implementations, the task workflow may include critical dates for the onboarding tasks, and the method may further include monitoring the completion of the onboarding tasks relative the critical dates and generating an alert signal upon a first condition where at least one onboarding task is not completed relative a corresponding critical date.

In some implementations, the onboarding data is at least one selected from the group consisting of user identification data, user ledger data, and compliance data.

In some implementations, onboarding tasks are at least one selected from the group consisting of document submission, compliance verification, and identity verification.

The above summary is provided merely for purposes of summarizing some example implementations to provide a basic understanding of some aspects of the present disclosure. Accordingly, it will be appreciated that the above-described implementations are merely examples and should not be construed to narrow the scope or spirit of the disclosure in any way. It will be appreciated that the scope of the present disclosure encompasses many potential implementations in addition to those here summarized, some of which will be further described below.

### BRIEF DESCRIPTION OF THE DRAWINGS

Having thus described implementations of the disclosure in general terms, reference will now be made the accompanying drawings. The components illustrated in the Figures may or may not be present in certain implementations described herein. Some implementations may include fewer (or more) components than those shown in the Figures.

FIGS. 1A-1C illustrate technical components of an exemplary distributed computing environment for data synchronization and data onboarding protocol using digital twins in a distributed network, in accordance with implementations of the disclosure;

FIG. 2 illustrates an exemplary machine learning model subsystem architecture, in accordance with implementations of the disclosure;

FIGS. 3A-3B illustrate an exemplary distributed ledger technology architecture, in accordance with implementations of the disclosure; and

FIG. 4 illustrates a process flow for data synchronization and data onboarding protocol using digital twins in a distributed network, in accordance with implementations of the disclosure.

### DETAILED DESCRIPTION

Implementations of the present disclosure will now be described more fully hereinafter with reference to the accompanying drawings, in which some, but not all, implementations of the disclosure are shown. Indeed, the disclosure may be implemented in many different forms and should not be construed as limited to the implementations set forth herein; rather, these implementations are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” may be also used herein. Furthermore, when it may be said herein that something may be “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the entity, its products or applications, the customers or any other aspect of the operations of the entity. As such, the entity may be any institution, group, association, financial institution, establishment, company, union, authority or the like, employing information technology resources for processing large amounts of data.

As described herein, a “user” may be an individual associated with an entity. As such, in some implementations, the user may be an individual having past relationships, current relationships or potential future relationships with an entity. In some implementations, the user may be an employee (e.g., an associate, a project manager, an IT specialist, a manager, an administrator, an internal operations analyst, or the like) of the entity or enterprises affiliated with the entity.

As used herein, a “user interface” or “display” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of a computer program, or part of a computer program that serves as a foundation for a larger piece of software and drives the functionality of the software. The term “engine” may be used herein interchangeably with “module” or “model”. An engine may be self-contained, but externally controllable code that encapsulates powerful logic designed to perform or execute a specific type of function. In one aspect, an engine may be underlying source code that establishes file hierarchy, input and output methods, and how a specific part of a computer program interacts or communicates with other software and/or hardware. The specific components of an engine may vary based on the needs of the specific computer program as part of the larger piece of software. In some implementations, an engine may be configured to retrieve resources created in other computer programs, which may then be ported into the engine for use during specific operational aspects of the engine. An engine may be configurable to be implemented within any general-purpose computing system. In doing so, the engine may be configured to execute source code embedded therein to control specific features of the general-purpose computing system to execute specific computing operations, thereby transforming the general-purpose system into a specific purpose computing system. In some implementations, an engine may implement a machine learning model or generative AI model to perform functions as a foundation for the larger piece of software that drives the functionality of the software. The machine learning model or generative AI model for any given engine may be self-contained (e.g., without interaction with other engines), or the machine learning model or generative AI model may be shared across one or more engines. In other words, some implementations of the larger piece of software many implement multiple machine learning models or generative AI models to perform functions of the various engines. In other implementations, a single machine learning model or generative AI model may be shared across one or more engines to perform the functions attributed thereto as described herein.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

It should be understood that the word “exemplary” may be used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that an element matches a predetermined criterion, including that a threshold has been met, passed, exceeded, and so on.

As used herein, “onboarding” may refer to the collective set of tasks and processes performed by an entity to integrate and establish a new client, whether the client is an individual user or a third-party entity. This onboarding may include the gathering, assessment, and validation of applicant data against relevant security, compliance, operational benchmarks, or the like to result in the adherence to regulatory and business standards. Onboarding may further include the configuration of client-specific parameters, the provision of necessary credentials or access, the execution of initial setup steps required to facilitate a transition into the entity's network, and so forth.

Onboarding systems used by entities typically operate through a combination of manually-driven processes and static rule-based algorithms to assess and validate applicant data against security, compliance, and operational requirements. These systems are architected around rigid workflows that process applications (i.e., applications to become a client of an entity, thus initiating onboarding) sequentially, often introducing latency due to dependencies on manual reviews for decision-making and approval. This architecture inherently lacks scalability, as the processing time increases proportionally with the volume of applications, resulting in a bottleneck during peak activity. Moreover, rule-based frameworks rely on static conditions derived from historical data and predefined criteria, which are incapable of adapting to the nuanced, dynamic nature of applicant behavior or emerging vulnerabilities. The system's inability to evaluate contextual or real-time factors during application processing further exacerbates inefficiencies and inaccuracies. As a consequence, applications deemed low-vulnerability may still face unnecessary delays, while real vulnerabilities remain unidentified due to the system's constrained analytical capabilities.

Current onboarding solutions, while perhaps providing a foundational level of automation, suffer from several technical deficiencies that hinder their effectiveness in addressing the problems identified in the foregoing. For example, the reliance on static rule-based systems limits their ability to respond to evolving applicant behaviors or emerging vulnerability patterns. These systems do not incorporate mechanisms for real-time scoring, dynamic prioritization, or context-aware decision-making, which are essential for improving efficiency and accuracy. Manual intervention remains an important component to these systems, as a result introducing subjectivity and inconsistency, while also adding to the overall processing time. Furthermore, these solutions lack advanced optimization techniques to prioritize application handling based on vulnerability assessment or resource availability, which exacerbates bottlenecks and delays during high-demand periods. Attempts to improve these systems through incremental updates to the rules or workflows often result in increased complexity, making the systems harder to manage and less adaptable over time. Consequently, existing solutions fail to address the dual objectives of reducing latency and improving decision accuracy, leaving the onboarding process fragmented and prone to inefficiencies.

The technical gap lies in the inability of existing onboarding systems to dynamically adapt to changing malfeasance tactics, prioritize tasks efficiently, and process applications in a scalable, context-aware manner. This gap results from the reliance on static rule-based frameworks and manual intervention, which are ill-suited for handling the complexities of real-time decision-making and high-volume processing. The long-felt need for a solution stems from the persistent inefficiencies, such as processing delays, false positives, and missed opportunities, which entities have been unable to overcome despite incremental improvements to existing systems. A comprehensive solution addressing these challenges would significantly improve operational efficiency, decision accuracy, and the overall user experience.

Thus, addressing these challenges requires the establishment of a system and method for data synchronization and data onboarding protocol using digital twins in a distributed network, which provides for integration of user data through an intelligent and adaptable framework. This framework uses machine learning model(s) and distributed ledger technology to enable efficient onboarding, task management, and real-time monitoring of user interactions.

To do so, onboarding data for a user may be received, for example, through an API or a web-based interface. This onboarding data may include identification data of the user, ledger information (resource transfers in the account(s) of a user), compliance data, or the like. Onboarding tasks may then be identified based on the identification data, which may be accomplished through the use of a machine learning model. The machine learning model may also be trained to create an onboarding workflow from the onboarding tasks identified, depending on the type of onboarding tasks or other information gathered. Throughout the onboarding process, onboarding tasks may be completed by the user, which results in the generation of task completion data that may be provided to the system in a stream. Upon receiving the stream of task completion data, completion of the various onboarding tasks in the task workflow may be logged. There may be critical dates (i.e., due dates) for at least some of the onboarding tasks. Thus, the system may monitor these onboarding tasks and generate an alert signal if the onboarding task is not completed before a critical date. Before, during, or after onboarding (i.e., the processes previously described), the user may generate, and thus the system may receive, a stream of interaction data, which results from various interactions between the user and the entity through an endpoint device. The system may provide this stream of interaction data to a second machine learning model for determining if any malfeasance has occurred. Such malfeasance may be determined by calculating (using the machine learning model) a malfeasance score and comparing it to a predetermined threshold. Whether or not malfeasance has been indicated by the system may then be recorded in a distributed ledger (i.e., blockchain) for recordkeeping. A digital twin may then be generated to represent the user, such that user activities may be simulated for the user based on interaction data, indications of malfeasance, or the like. The digital twin may include a module for receiving real-time transfer data and other data streams, and use an onboarding criteria adjustment module for recalibrating the malfeasance indicator threshold based on simulated user activities of the digital twin.

What is more, the present disclosure provides a technical solution to a technical problem. As described herein, the technical problem includes inefficiencies in user onboarding and malfeasance detection processes that require excessive manual oversight, rigid rule-based system, and a lack of real-time adaptive mechanisms to handle evolving user interactions. The present disclosure embraces an improvement over existing solutions by introducing an automated and dynamic framework to provide real-time updates, adaptive malfeasance detection, and predictive onboarding criteria adjustments (i) with fewer steps to achieve the solution (e.g., automating task assignment and monitoring through an integrated digital strategy automation engine, thereby eliminating manual intervention and reducing delays in user onboarding workflows), thus reducing the amount of network resources, such as processing resources, storage resources, network resources, and/or the like, that are being used, (ii) providing a more accurate solution to problem, thus reducing the number of resources required to remedy any errors made due to a less accurate solution (e.g., using machine learning for malfeasance detection and vulnerability assessment, which dynamically adjust thresholds based on real-time data, thereby minimizing false positives and unnecessary client rejections), (iii) removing manual input and waste from the implementation of the solution, thus improving speed and efficiency of the process and conserving network resources (e.g., integrating APIs and real-time data streams into the digital twin infrastructure to automate updates, recalibrate onboarding criteria, and reduce dependency on human oversight), (iv) determining an optimal amount of resources that need to be used to implement the solution, thus reducing network traffic and load on existing network resources (e.g., utilizing distributed ledger technology to synchronize and securely store tamper-proof records across decentralized nodes, ensuring efficient data handling and minimizing redundant computations). In other words, the solution may bypass a series of steps previously implemented, thus further conserving network resources. Furthermore, the technical solution described herein uses a rigorous, computerized process to perform specific tasks and/or activities that were not previously performed.

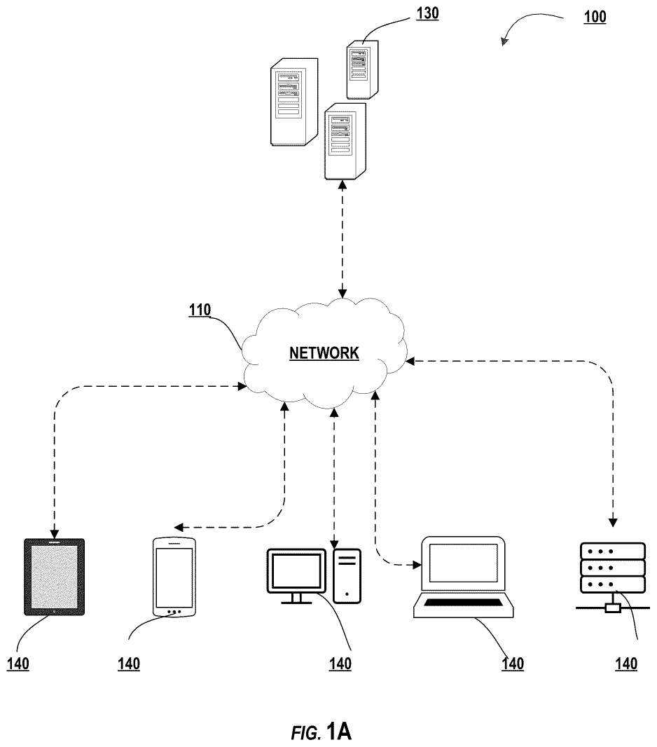

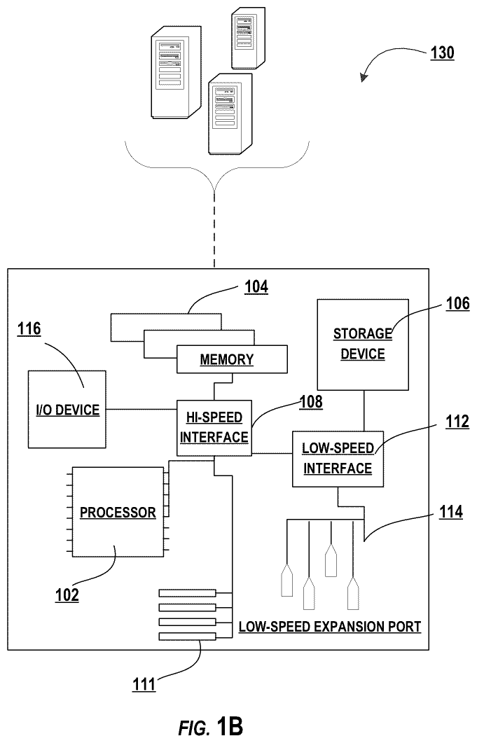

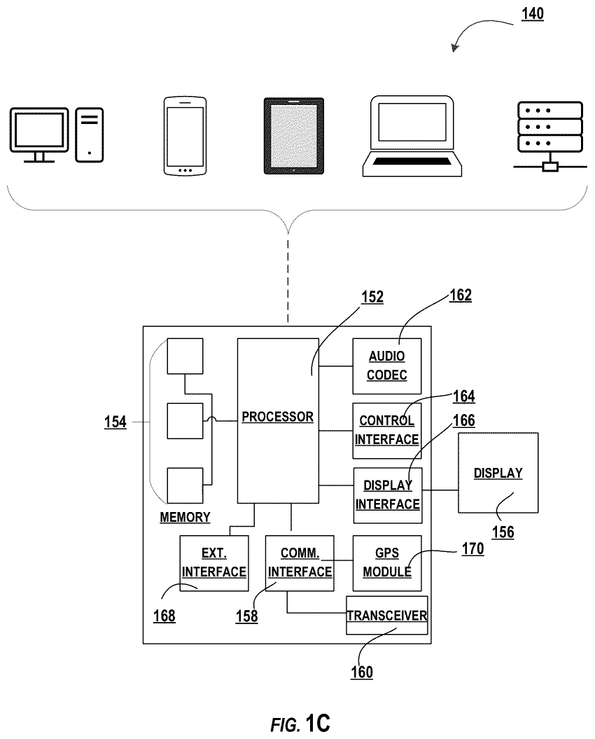

FIGS. 1A-1C illustrate technical components of an exemplary distributed computing environment 100 for data synchronization and data onboarding protocol using digital twins in a distributed network, in accordance with an implementation of the disclosure. As shown in FIG. 1A, the distributed computing environment 100 contemplated herein may include a system 130, an endpoint device(s) 140, and a network 110 over which the system 130 and endpoint device(s) 140 communicate therebetween. FIG. 1A illustrates only one example of an implementation of the distributed computing environment 100, and it will be appreciated that in other implementations one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some implementations, the system 130 and the endpoint device(s) 140 may have a client-server relationship in which the endpoint device(s) 140 are remote devices that request and receive application from a centralized server, i.e., the system 130. In some other implementations, the system 130 and the endpoint device(s) 140 may have a peer-to-peer relationship in which the system 130 and the endpoint device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The endpoint device(s) 140 may represent various forms of electronic devices, including user input devices such as personal digital assistants, cellular telephones, smartphones, laptops, desktops, and/or the like, input devices such as resource transfer terminals, electronic resource transfer units, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. In addition to shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an implementation of the disclosure. As shown in FIG. 1B, the system 130 may include a processing device 102, memory 104, input/output (I/O) device 116, and a storage device 106. The system 130 may also include a high-speed interface 108 connecting to the memory 104, and a low-speed interface 112 connecting to a low-speed bus 114 and a storage device 106. Each of the components 102, 104, 108, 110, and 112 may be operatively coupled to one another using various buses and may be mounted on a common motherboard or in other manners as appropriate. As described herein, the processing device 102 may include a number of subsystems to execute the portions of processes described herein. Each subsystem may be a self-contained component of a larger system (e.g., system 130) and capable of being configured to execute specialized processes as part of the larger system.

The processing device 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processing devices, along with multiple memories, and/or I/O devices, to execute the processes described herein. In other words, as used herein, a “processing device” means one processing device (e.g., a microprocessor) that performs the defined functions or a plurality of processing devices (e.g., microprocessors) that collectively perform defined functions such that the execution of the individual defined functions may be divided amongst such processing devices.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly implemented in an information carrier. The computer program product may also contain instructions that, when executed, perform one or more methods, such as those described above. The information carrier may be a non-transitory computer-or machine-readable storage medium, such as the memory 104, the storage device 106, or memory on processing device 102.

The high-speed interface 108 manages bandwidth-intensive operations for the system 130, while the low-speed controller 112 manages lower bandwidth-intensive operations. Such allocation of functions is exemplary only. In some implementations, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the endpoint device(s) 140, in accordance with an implementation of the disclosure. As shown in FIG. 1C, the endpoint device(s) 140 includes a processing device 152, memory 154, an input/output device such as a display 156, a communication interface 158, and a transceiver 160, among other components. The endpoint device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processing device 152 is configured to execute instructions within the endpoint device(s) 140, including instructions stored in the memory 154, which in one implementation includes the instructions of an application that may perform the functions disclosed herein, including certain logic, data processing, and data storing functions. The processing device may be implemented as a chipset of chips that include separate and multiple analog and digital processors. The processing device may be configured to provide, for example, for coordination of the other components of the endpoint device(s) 140, such as control of user interfaces, applications run by endpoint device(s) 140, and wireless communication by endpoint device(s) 140.

The processing device 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processing device 152. In addition, an external interface 168 may be provided in communication with processing device 152, so as to enable near area communication of endpoint device(s) 140 with other devices. External interface 168 may provide, for example, for wired communication in some implementations, or for wireless communication in other implementations, and multiple interfaces may also be used.

The memory 154 stores information within the endpoint device(s) 140. The memory 154 can be implemented as one or more of a computer-readable medium or media, a volatile memory unit or units, or a non-volatile memory unit or units. Expansion memory may also be provided and connected to endpoint device(s) 140 through an expansion interface (not shown), which may include, for example, a SIMM (Single In Line Memory Module) card interface. Such expansion memory may provide extra storage space for endpoint device(s) 140 or may also store applications or other information therein. In some implementations, expansion memory may include instructions to carry out or supplement the processes described above and may include secure information also. For example, expansion memory may be provided as a security module for endpoint device(s) 140 and may be programmed with instructions that permit secure use of endpoint device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly implemented in an information carrier. The computer program product contains instructions that, when executed, perform one or more methods, such as those described herein. The information carrier is a computer-or machine-readable medium, such as the memory 154, expansion memory, memory on processing device 152, or a propagated signal that may be received, for example, over transceiver 160 or external interface 168.

In some implementations, the user may use the endpoint device(s) 140 to transmit and/or receive information or commands to and from the system 130 via the network 110. Any communication between the system 130 and the endpoint device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the endpoint device(s) 140 may provide the system 130 (or other client devices) permissioned access to the protected resources of the endpoint device(s) 140, which may include a GPS device, an image capturing component (e.g., camera), a microphone, and/or a speaker.

The endpoint device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to endpoint device(s) 140, which may be used as appropriate by applications running thereon, and in some implementations, one or more applications operating on the system 130.

The endpoint device(s) 140 may also communicate audibly using audio codec 162, which may receive spoken information from a user and convert the spoken information to usable digital information. Audio codec 162 may likewise generate audible sound for a user, such as through a speaker, e.g., in a handset of endpoint device(s) 140. Such sound may include sound from voice telephone calls, may include recorded sound (e.g., voice messages, music files, etc.) and may also include sound generated by one or more applications operating on the endpoint device(s) 140, and in some implementations, one or more applications operating on the system 130.

Various implementations of the distributed computing environment 100, including the system 130 and endpoint device(s) 140, and techniques described here can be realized in digital electronic circuitry, integrated circuitry, specially designed ASICs (application specific integrated circuits), computer hardware, firmware, software, and/or combinations thereof.

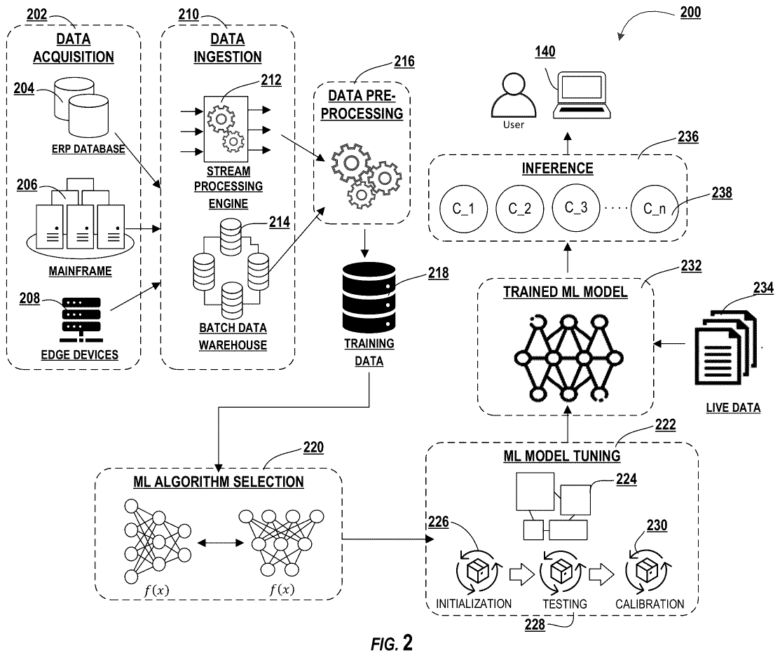

FIG. 2 illustrates an exemplary machine learning model subsystem architecture 200, in accordance with an implementation of the disclosure. The machine learning subsystem 200 may include a data acquisition engine 202, data ingestion engine 210, data pre-processing engine 316, machine learning model tuning engine 222, and inference engine 236.

The data acquisition engine 202 may identify various internal and/or external data sources to generate, test, and/or integrate new features for training the machine learning model. These internal and/or external data sources 204, 206, and 208 may be initial locations where the data originates or where physical information is first digitized. The data acquisition engine 202 may identify the location of the data and describe connection characteristics for access and retrieval of data. In some implementations, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other applications. In some implementations, the these data sources 204, 206, and 208 may include Enterprise Resource Planning (ERP) databases or protocol databases that host data related to day-to-day enterprise activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of network resources to process. Feature extraction and/or selection may be used to select and/or combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points. As will be understood in view of the present disclosure, training data 218 may additionally, or alternatively, be provided from a third party, having been generated as synthetic data.

The machine learning model tuning engine 222 may be used to train a machine learning model to form a trained machine learning model 232 using the training data 218 to make predictions or decisions without explicitly being programmed to do so. The machine learning model 232 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms can adjust their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the machine learning model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the machine learning model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical enterprise decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

It shall be understood that the implementation of the machine learning subsystem 200 illustrated in FIG. 2 is exemplary and that other implementations may vary. As another example, in some implementations, the machine learning subsystem 200 may include more, fewer, or different components.

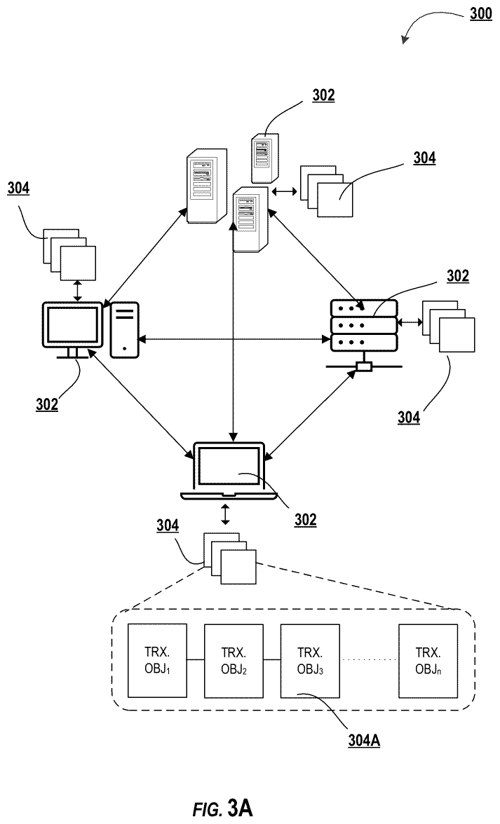

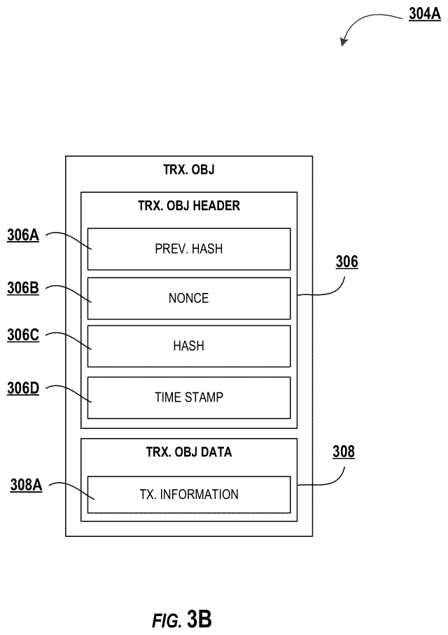

FIGS. 3A-3B illustrate an exemplary distributed ledger technology (DLT) architecture, in accordance with an implementation of the disclosure. DLT may refer to the protocols and/or supporting infrastructure that allow computing devices (peers) in different locations to propose and validate transactions and update records in a synchronized way across a network. Accordingly, DLT is based on a decentralized model, in which these peers collaborate and build trust over the network. To this end, DLT involves the use of potentially peer-to-peer protocol for a cryptographically secured distributed ledger of transactions represented as transaction objects that are linked. As transaction objects each contain information about the transaction object previous to it, they are linked with each additional transaction object, reinforcing the transaction objects before it. Therefore, distributed ledgers are resistant to modification of their data because once recorded, the data in any given transaction object cannot be altered retroactively without altering all subsequent transaction objects.

To permit transactions and agreements to be carried out among various peers without the need for a central authority or external enforcement mechanism, DLT uses smart contracts. Smart contracts are computer code that automatically execute all of or parts of an agreement and are stored on a DLT platform. The code can either be the sole manifestation of the agreement between the parties or might complement a traditional text-based contract and execute certain provisions, such as transferring funds from Party A to Party B. The code itself may be replicated across multiple nodes (peers) and, therefore, may benefit from the security, permanence, and immutability that a distributed ledger offers. That replication also means that as each new transaction object is added to the distributed ledger, the code is, in effect, executed. If the parties have indicated, by initiating a transaction, that certain parameters have been met, the code will execute the step triggered by those parameters. If no such transaction has been initiated, the code will not take any steps.

Various other specific-purpose implementations of distributed ledgers have been developed. These include distributed domain name management, decentralized crowd-funding, synchronous/asynchronous communication, decentralized real-time ride sharing and even a general purpose deployment of decentralized applications. In some implementations, a distributed ledger may be characterized as a public distributed ledger, a consortium distributed ledger, or a private distributed ledger. A public distributed ledger is a distributed ledger that anyone in the world can read, anyone in the world may send transactions to and expect to see them included if they are valid, and anyone in the world can participate in the consensus process for determining which transaction objects are added to the distributed ledger and what the current state of each transaction object is. A public distributed ledger is generally considered to be fully decentralized. On the other hand, a fully private distributed ledger is a distributed ledger whereby permissions are kept centralized with one entity. The permissions may be public or restricted to an arbitrary extent. And lastly, a consortium distributed ledger is a distributed ledger where the consensus process is controlled by a pre-selected set of nodes; for example, a distributed ledger may be associated with a number of member institutions (say 15), each of which operate in such a way that at least 10 members must sign every transaction object in order for the transaction object to be valid. The right to read such a distributed ledger may be public or restricted to the participants. These distributed ledgers may be considered partially decentralized.

As shown in FIG. 3A, the exemplary DLT architecture 300 may include a distributed ledger 304 being maintained on multiple devices (nodes) 302 that are authorized to keep track of the distributed ledger 304. For example, the nodes 302 may be computing devices such as the system 130 and the endpoint device(s) 140. One node of the nodes 302 in the DLT architecture 300 may have a complete or partial copy of the entire distributed ledger 304 or may have a set of transactions and/or transaction objects 304A on the distributed ledger 304. Transactions may be initiated at a node and communicated to the nodes 302 in the DLT architecture 300. Any of the nodes 302 may validate a transaction, record the transaction to its copy of the distributed ledger, and/or broadcast the transaction, its validation (in the form of a transaction object), and/or other data to other nodes.

As shown in FIG. 3B, an exemplary transaction object 304A may include a transaction object header 306 and transaction object data 308. The transaction object header 306 may include a cryptographic hash of a previous transaction object 306A, a nonce 306B (e.g., a randomly generated 32-bit whole number when the transaction object 304A is created), a cryptographic hash of the current transaction object 306C wedded to the nonce 306B, and/or a time stamp 306D. The transaction object data 308 may include transaction information 308A being recorded. Once the transaction object 304A is generated, the transaction information 308A is considered signed and forever tied to the nonce 306B and the cryptographic hash 306C. Once generated, the transaction object 304A is then deployed on the distributed ledger 304. At this time, a distributed ledger address may be generated for the transaction object 304A (e.g., an indication of where the transaction object 304A is located on the distributed ledger 304) and may be captured for recording purposes. Once deployed, the transaction information 308A is considered recorded in the distributed ledger 304.

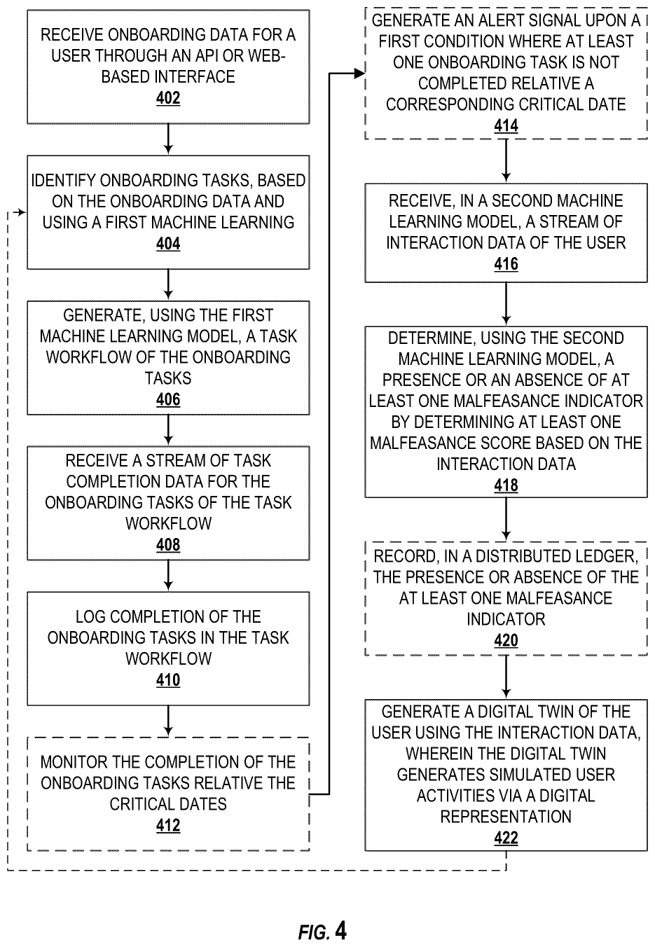

FIG. 4 illustrates a process flow for data synchronization and data onboarding protocol using digital twins in a distributed network, in accordance with an implementation of the disclosure. The process may begin at block 402, where the system receives onboarding data for a user.

As used herein, “onboarding data” may refer to information collected and processed to facilitate the integration of a user into a system, platform, or service. This data may include, but is not limited to, user identification data, user ledger data, and compliance data. User identification data may include personally identifiable information such as names, addresses, email addresses, phone numbers, and government-issued identifiers (e.g., driver's license, passport numbers, or the like). User ledger data may include financial or transactional records associated with the user, including account balances, transaction histories, payment methods, or billing preferences. Compliance data may include information necessary to satisfy legal or regulatory requirements, such as proof of address, tax identification numbers, anti-money laundering (AML) certifications, results from know-your-customer (KYC) checks, or the like.

Onboarding data may be received through various channels, including application programming interfaces (APIs) or web-based interfaces, to facilitate integration into the system. When received via API, the onboarding data may be transmitted directly from external systems or applications using structured requests providing a standardized data exchange. For example, user identification data may be submitted through an API endpoint designed to handle encrypted payloads. Additionally, or alternatively, web-based interfaces may allow users to input onboarding data manually through interactive forms or upload required documents directly. These interfaces may support the collection of user ledger data by permitting the user to link financial accounts or specify payment preferences, while compliance data may be uploaded in the form of scanned identification documents or validated through automated KYC checks integrated into the web-based portal.

Next, at block 404, the system may identify onboarding tasks from the onboarding data. To do so, the system may implement a first machine learning model. The first machine learning model may include a natural language processing engine and may be trained to identify onboarding tasks based on patterns, keywords or contextual relationships within the onboarding data. The system may analyze textual or structured input, such as documents, forms, or communications, to extract actionable onboarding tasks. The natural language processing engine may classify, segment, or label portions of the data to discern onboarding tasks relevant to onboarding processes. The first machine learning model may rely on pre-defined training datasets or dynamically learn from user feedback to improve onboarding task identification accuracy over time.

Examples of onboarding tasks may include document submission, compliance verification, identity verification, or the like. Onboarding tasks may also include the creation of user accounts, assignment of access credentials, configuration of user-specific settings, completion of training modules, collection of required signatures or consents, verification of payment or billing information, or the like. Onboarding tasks may also include reviewing policy acknowledgments, scheduling orientation sessions, providing relevant resources or tools, and confirming the successful integration of the user into the associated system or platform.

At block 406, the system may generate a task workflow using the first machine learning model. The task workflow may include a schedule and/or sequence of the onboarding tasks identified in block 404 to be completed by a user. The workflow may also define dependencies between tasks to ensure that prerequisite tasks are completed before subsequent tasks are initiated. Additionally, the workflow may incorporate deadlines (i.e., “critical dates”), reminders, or notifications to guide the user through the process efficiently. The system may customize the workflow based on user-specific attributes, such as role, location, or prior onboarding progress, to ensure relevance and adherence to organizational requirements. The workflow may be dynamically updated in response to changes in task completion status, user feedback, or modifications to onboarding criteria.

In some implementations, the task workflows may be predefined, for example, in accordance with predefined regulatory checklists or organizational standards. These predefined task workflows may ensure compliance with specific requirements. The task workflows may be stored in a task workflow repository to retrieve, adapt, or reuse workflows based on user characteristics or contextual onboarding scenarios. The task workflow repository may also facilitate version control.

In other implementations, the task workflows may be dynamic, such that the system automatically adjusts the sequence, schedule, or content of the workflows in real-time based on contextual factors. These factors may include user input, external data sources (e.g., regulatory updates or market conditions), or system-detected anomalies.

Additionally, or alternatively, the task workflows may be adjusted (i.e., the sequence, schedule, or content adjusted) based on the activity of a digital twin, as will be described in detail herein. For example, a digital twin that represents a user undergoing the onboarding process may provide, predictively via various module(s) therein, or retroactively based on ongoing or past activities of the user, interaction data that the first machine learning model takes into consideration in prescribing additional steps or other onboarding tasks to complete in an effort to mitigate exposure to malfeasance of the user.

Continuing at block 408, the system may receive a stream of task completion data for the onboarding tasks of the task workflow. The task completion data may be received from various sources, including user interactions with an onboarding portal, automated system logs, or third-party integrations. The data may include timestamps, task identifiers, and status updates indicating whether a task has been completed, partially completed, or requires further action. The system may process this data in real time or batch mode to track the progress of the onboarding process.

Next, at block 410, the logging of completion of the onboarding tasks in the task workflow may occur. The system may update the task workflow with the received task completion data, marking corresponding tasks as completed within the workflow. Logged data may include metadata such as the user responsible for completing the task, the method of completion, and any associated documentation or evidence. This logged information may be stored in a centralized database or task workflow repository for traceability and compliance with regulatory or organizational requirements. Additionally, or alternatively, the logged information may be stored in a distributed ledger for transparency and record-keeping relative the user.

The process may continue at block 412, where the system monitors the completion of the onboarding tasks relative the critical dates. Monitoring may be achieved through various methods to ensure timely and accurate tracking. For example, the system may maintain a centralized log that records the completion status of each task, with the system updating the log in real time or at predefined intervals. A scheduling component may track task deadlines by comparing due dates with the current date and triggering alerts for overdue or near-due tasks.

Additionally, or alternatively, the system may collect status updates from users or stakeholders through surveys or direct input to supplement automated tracking. Integration with external platforms, such as project management computer applications, may allow the system to import task progress and deadlines for consistency. A visual dashboard may present real-time indicators, such as progress bars or color-coded markers, to provide clear visibility into task status. Event-based monitoring may track specific actions, such as approvals or file submissions, that signify task completion and automatically update records. In some implementations, predictive analytics may be utilized to forecast delays by analyzing historical data, resource allocation, and other factors and inputting into a machine learning model.

At block 414, the system may generate an alert signal upon a first condition where at least one onboarding task is not completed relative a corresponding critical date. The alert signal may include descriptors for the onboarding task and/or critical date corresponding thereto. The alert signal may be in a digital data format that relies on discrete logic to represent information or may be analog. In some implementations, the alert signal may present data in a packet-based structure that uses headers, payload fields, and parity bits for error detection. In some implementations, the alert signal may rely on standardized data integrity protocols and may adhere to a predetermined communications standard.

The system may transmit the alert signal to an endpoint device. The endpoint device may belong to the entity and may be used by a user associated with the entity to monitor onboarding tasks.

As such, the alert signal may cause the endpoint device to display an alert banner. The alert banner may include a structured data payload formatted in a markup language (e.g., HTML, XML, or JSON) or a proprietary format, where the payload may include parameters, such as text content (e.g., the account identifier, the aggregate requirements index, obligation record details, and/or a rate of the change of the aggregate requirements index), font attributes (e.g., typeface, size, color), background color, layout dimensions, priority level, and display duration. Metadata fields may specify banner type (e.g., error, warning, informational), language localization codes, and expiration timestamps. The payload may also include embedded hyperlinks or icons, represented through base64-encoded images or reference URIs. To transmit the alert, the system may dispatch the payload via a communication protocol such as HTTP/HTTPS, MQTT, or WebSocket, possibly with encryption (e.g., TLS) for secure transmission. The endpoint device may receive the payload through a listening service, notification handler, or the like, parse the received data to extract display instructions, and pass these instructions to a graphical rendering engine of the endpoint device. The rendering engine may convert the formatting directives into a visually styled banner and overlay it within the user interface.

The system may receive, from the endpoint device, a feedback signal generated at the endpoint device in response to the alert. For example, a user may wish to extend the critical date by a predetermined length of time (e.g., 1 hour, 1 day, 1 week, or the like). To do so, event listeners within the endpoint device detect interactions with the banner (e.g., clicks on interaction elements such as buttons, slides on a slider, or the like) and trigger predefined actions or dismissals. In other words, the system may receive a feedback signal that is generated from an interaction with the alert banner, at the endpoint device (e.g., from the user clicking on an interaction element).

In some implementations, the system may transmit the feedback signal to the first machine learning model as training data. The feedback signal may originate from the system's output and represent the deviation between the predicted critical date and the actual date on which the onboarding task is completed. The feedback signal may adjust weights within the machine learning model to minimize the error function, thereby enhancing prediction accuracy over successive training cycles.

Continuing at block 416, the system may receive, in a second machine learning model, a stream of interaction data of the user. The interaction data may be resource transfer data (e.g., financial transactions), geolocation data, endpoint device usage patterns, or the like. For example, resource transfer data may include details of financial transactions such as transaction amounts, frequency of transfers, recipient account locations, or payment methods utilized (e.g., credit card, ACH transfer, cryptocurrency). Geolocation data may include the endpoint device's physical locations during transactions, such as GPS coordinates during login attempts or the origin of cross-border payments. Endpoint device usage patterns may include details like the type of device (e.g., smartphone, tablet, or desktop), the operating system version, browser configurations, identifiers such as MAC addresses, device fingerprints, or the like.

Additionally, or alternatively, interaction data may include login behavior, including timestamps of access attempts, failed login attempts, unusual session durations, and so forth. Additionally, or alternatively, interaction data may include communication metadata which could include details of communication events, such as timestamps of messages sent to support, channels of communication (e.g., email, chat), or response times. Additionally, or alternatively, interaction data may include behavioral data anomalies such as rapid inputs, deviations from typical navigation paths, changes in preferred access points (e.g., switching from mobile to desktop), or the like. Additionally, or alternatively, interaction data may include historical compliance data, including prior document submissions and verification outcomes.

It shall be appreciated that in some implementations, the first machine learning model and the second machine learning model are the same machine learning model. In such implementations, the single machine learning model may operate in a dual capacity, performing tasks associated with both the first and second models by leveraging shared parameters, architectures, or datasets. In other implementations, the first machine learning model and the second machine learning model are distinct models separate from one another.

Next, at block 418 the system may determine a presence or an absence of at least one malfeasance indicator using the second machine learning model. To do so, the second machine learning model may determine at least one malfeasance score based on the interaction data.

In some implementations, the machine learning model determines a probability score for malicious activity based on interaction data, such as resource transfer data, geolocation data, and endpoint device usage patterns. In these implementations, the second machine learning model processes resource transfer data to identify anomalous patterns, such as unusual spikes in transfer volume or frequency, which may indicate malicious intent. In some implementations, geolocation data is analyzed to detect unexpected or inconsistent geographic locations, such as simultaneous logins from disparate regions, which could signal compromised accounts. Additionally, or alternatively, endpoint device usage patterns may be evaluated to identify deviations from normal behavior, such as atypical login times, rapid session terminations, or unexpected changes in device type or operating system.

In some implementations, the second machine learning model extracts features from the interaction data by quantifying attributes such as average resource transfer size, geolocation variance, and endpoint access frequency. These features may be weighted by the second machine learning model based on their relevance to identifying malicious activity, with weights derived from training on historical datasets containing both normal and malicious interaction examples. In some implementations, the weighted features are combined using a probabilistic function to calculate a composite score (i.e., a “malfeasance score”) that represents the likelihood of malicious behavior.

The second machine learning model may compare the at least one malfeasance score with predetermined malfeasance indicator thresholds such that malfeasance score(s) above or below the predetermined malfeasance indicator threshold(s) may be indicative of malicious activity. These predetermined malfeasance indicator threshold(s) may be pre-set based on historical data or through empirical testing. In some implementations, the predetermined malfeasance indicator(s) may be set by the second machine learning model, such that the thresholds are dynamically adjusted based on ongoing analysis of input data, allowing the model to refine its sensitivity to new patterns of malicious activity. This adaptive adjustment may involve identifying trends in the input data that indicate emerging threats, thereby improving the model's accuracy and responsiveness.

The process may continue at block 420, where the system records, in a distributed ledger, the presence or absence of the at least one malfeasance indicator. The at least one malfeasance indicator may be associated with the user through various identifiers, such as a unique user identifier, a cryptographic hash derived from the user's credentials, or biometric data tied to the individual. In some implementations, the malfeasance indicator may be linked to user-specific metadata. For example, the malfeasance indicator may be linked to certain device identifiers associated with the user. Additionally, or alternatively, the malfeasance indicator may be linked to transaction records associated with the user, behavioral patterns, or the like. Additionally, or alternatively, in the distributed ledger, a malfeasance score derived from the evaluation of the at least one malfeasance indicator may be recorded.

At block 422, the system may generate a digital twin of the user. As used herein, a “digital twin” may refer to a virtual representation of a user or entity subject to onboarding, wherein the virtual representation is configured to replicate the attributes, behaviors, and operational parameters of the corresponding physical counterpart in real-time or near-real-time.

In some implementations, the digital twin may be generated based on the interaction data. This interaction data, being a historical account of the user's activities, provides a basis for simulating and/or replicating user activities within a digital representation. The interaction data may include metadata, behavioral patterns, contextual inputs, and specific task execution histories that reflect the user's preferences and decision-making processes. By analyzing and structuring this data, the system may construct a dynamic and adaptable digital model that mirrors the user's tendencies and responses. Accordingly, the digital twin may simulate potential user behaviors in varying scenarios to provide predictions and personalized activity monitoring. The generation process may use machine learning algorithms or data-driven models to enable the digital twin to adapt as new interaction data is received. In doing so, an accurate and up-to-date representation is maintained. Stated differently, the digital twin generates simulated user activities via a digital representation.

The structure of the digital twin may take one of many different forms. In some implementations, the digital twin may include a data integration module. This data integration module may be operatively coupled to real-time data sources to receive interaction data. In doing so, this data integration module may be configured to provide to the digital twin the incoming interaction data to be used to continuously update the digital representation of the user within the digital twin with the real-time data sources.

These real-time data sources may include, for example, resource transfer gateways which are configured to receive resource transfer requests between the user and the entity. These gateways may collect and process data associated with each resource transfer, such as the timestamp indicating the precise moment of the transaction, the geographic location from which the request originates, user authentication credentials, transaction identifiers, details regarding the resources being transferred, including their type, amount, and destination, or the like.

In some implementations, the digital twin may also include a predictive analytics engine configured to generate the simulated user activities based on the historical interaction data and the interaction data received in real-time (or near real-time). The predictive analytics engine may utilize various machine learning models, including regression models, classification algorithms, neural networks, or ensemble methods, to analyze the patterns in the historical data and predict likely user activities. For example, a neural network may be trained on a dataset comprising historical user behaviors to identify complex patterns, while a decision tree model may be employed for interpreting straightforward branching decision logic.

The predictive analytics engine may further improve its predictions through reinforcement learning techniques. In such implementations, the predictive analytics engine may iteratively refine its prediction models by receiving feedback on the accuracy of its previous predictions. This feedback loop allows for the adaptation of the digital twin to evolving user behavior over time. In turn, the digital twin provides an increased precision, over time, in the simulated activities.

Additionally, or alternatively, the predictive analytics engine may implement rule-based logic to supplement or validate its machine learning outputs. This rule-based logic may include predefined rules based on domain-specific knowledge, which may define constraints or guidelines for user interactions. In doing so, the adherence of the simulated results to logical and/or operational boundaries may be improved.

In some implementations, the predictive analytics engine may use real-time data streams (e.g., sensor inputs, system telemetry, external contextual information such as environmental data, market trends, or the like). By integrating these real-time inputs, the predictive analytics engine may adjust its predictions to reflect immediate changes in conditions. For example, the predictive analytics engine may predict a user's next activity in a workflow by correlating real-time interaction data with historical interaction data sequences.

In some implementations, the predictive analytics engine may implement federated learning to protect user data privacy. In other words, federated learning may allow the predictive analytics engine to train models across multiple decentralized data sources without sharing raw data.

Additionally, or alternatively, the predictive analytics engine may use probabilistic graphical models, such as Bayesian networks, to represent and compute the likelihood of various user activity scenarios. Such models may explicitly encode dependencies among variables and provide interpretable insights into the factors driving predicted activities.

Additionally, or alternatively, the predictive analytics engine may incorporate feature selection techniques or dimensionality reduction methods, such as principal component analysis (PCA) or the like, to focus on the most relevant variables. In doing so, computational overhead may be minimized while maintaining predictive accuracy.

In some implementations, the predictive analytics engine may combine heuristic approaches with other analytics. For example, a heuristic algorithm may identify a coarse-grained set of likely activities of the user, which the predictive model then refines to generate a more detailed and accurate prediction or user behavior.

In some implementations, the digital twin may include an onboarding criteria adjustment module operatively coupled to the predictive analytics engine. The onboarding criteria adjustment model may be configured to recalibrate the predetermined malfeasance indicator thresholds of block 418 in response to the simulated user activities. By analyzing the simulated user behaviors generated by the predictive analytics engine, the onboarding criteria adjustment module may detect trends or anomalies that suggest the need to modify the thresholds associated with malfeasance detection. In some implementations, the onboarding criteria adjustment module may use adaptive algorithms, such as dynamic threshold adjustment models, Bayesian optimization techniques, or the like, to recalibrate the malfeasance thresholds in real time. For example, if the simulated activities indicate a shift in the baseline behavior of legitimate users, the module may adjust the thresholds upward or downward to minimize false-positive or false-negative detections.

In some configurations, the onboarding criteria adjustment module may integrate feedback loops to refine its recalibration process. Such feedback may include inputs from users, system audits, downstream validation systems, or the like to assess the adjusted thresholds effectiveness in accurately identifying malfeasance. Using this feedback, the module may iteratively improve its adjustment logic. In some implementations, the onboarding criteria adjustment module may include contextual analysis to refine its recalibration strategy. For example, external factors such as regulatory changes may be incorporated into the recalibration process to ensure the malfeasance detection framework remains robust. In some implementations, the onboarding criteria adjustment module may weigh these external factors to prioritize adjustments that are most relevant to the operational context.

In some implementations, to improve adaptability, the onboarding criteria adjustment module may utilize multi-criteria decision-making algorithms. In some implementations, the onboarding criteria adjustment module may provide predictive recalibration, where the recalibration process anticipates potential future trends based on simulated activities and adjusts the thresholds proactively. For example, if the predictive analytics engine forecasts an increase in certain high-vulnerability behaviors, the module may preemptively lower the thresholds for related malfeasance indicators to enable earlier detection and response.

In some implementations, the onboarding criteria adjustment module may provide auditability features, such as logging the rationale behind each threshold adjustment (for example, in the distributed ledger) and generating reports for stakeholders. In doing so, this may provide traceability in the recalibration process for regulatory compliance or stakeholder confidence.

In some implementations, output(s) from the onboarding criteria adjustment module may be provided to the first machine learning model at blocks 404-408 to provide the first machine learning model the ability to determine additional onboarding tasks to be completed, an alternate workflow of the onboarding tasks, or the like, for the user. In doing so, onboarding is tailored to the user based on the interaction data of the user, which will increase or decrease the amount of oversight required to successfully onboard the user or to end the onboarding of the user.

As will be appreciated by one of ordinary skill in the art, the present disclosure may be implemented as an apparatus (including, for example, a system, a machine, a device, a computer program product, and/or the like), as a method (including, for example, an enterprise process, a computer-implemented process, and/or the like), as a computer program product (including firmware, resident software, micro-code, and the like), or as any combination of the foregoing. Many modifications and other implementations of the present disclosure set forth herein will come to mind to one skilled in the art to which these implementations pertain having the benefit of the teachings presented in the foregoing descriptions and the associated drawings. Although the Figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A system for data synchronization and data onboarding protocol using digital twins in a distributed network, the system comprising:
a processing device; and
a non-transitory storage device containing instructions, when executed by the processing device, the instructions cause the processing device to perform the steps of:
receiving onboarding data for a user, wherein the onboarding data is received through an API or web-based interface;
identifying, based on the onboarding data and using a first machine learning model comprising natural language processing, onboarding tasks;
generating, using the first machine learning model, a task workflow of the onboarding tasks;
receiving a stream of task completion data for the onboarding tasks of the task workflow;
logging completion of the onboarding tasks in the task workflow;
receiving, in a second machine learning model, a stream of interaction data of the user, wherein the interaction data is at least one selected from the group consisting of resource transfer data, geolocation data, and endpoint device usage patterns;
determining, using the second machine learning model, a presence or an absence of at least one malfeasance indicator by determining at least one malfeasance score based on the interaction data and comparing the at least one malfeasance score with predetermined malfeasance indicator thresholds; and
generating a digital twin of the user using the interaction data, wherein the digital twin generates simulated user activities via a digital representation.

2. The system of claim 1, wherein the instructions further cause the processing device to perform the steps of:
recording, in a distributed ledger, the presence or absence of the at least one malfeasance indicator.

3. The system of claim 1, wherein the digital twin comprises:
a data integration module operatively coupled to real-time data sources, the real-time data sources comprising resource transfer gateways, the data integration module continuously updating the digital representation with the real-time data sources;
a predictive analytics engine configured to generate the simulated user activities based on historical and real-time data; and
an onboarding criteria adjustment module, operatively coupled to the predictive analytics engine, configured to dynamically recalibrate the predetermined malfeasance indicator thresholds in response to the simulated user activities.

4. The system of claim 1, wherein the task workflow comprises critical dates for the onboarding tasks, and wherein the instructions further cause the processing device to perform the steps of:
monitoring the completion of the onboarding tasks relative the critical dates; and
generating an alert signal upon a first condition where at least one onboarding task is not completed relative a corresponding critical date.

5. The system of claim 1, wherein the onboarding data is at least one selected from the group consisting of user identification data, user ledger data, and compliance data.

6. The system of claim 1, wherein onboarding tasks are at least one selected from the group consisting of document submission, compliance verification, and identity verification.

7. The system of claim 1, wherein the first machine learning model and the second machine learning model are the same machine learning model.

8. A computer program product for data synchronization and data onboarding protocol using digital twins in a distributed network, the computer program product comprising a non-transitory computer-readable medium comprising code causing an apparatus to:
receive onboarding data for a user, wherein the onboarding data is received through an API or web-based interface;
identify, based on the onboarding data and using a first machine learning model comprising natural language processing, onboarding tasks;
generate, using the first machine learning model, a task workflow of the onboarding tasks;
receive a stream of task completion data for the onboarding tasks of the task workflow;
log completion of the onboarding tasks in the task workflow;
receive, in a second machine learning model, a stream of interaction data of the user, wherein the interaction data is at least one selected from the group consisting of resource transfer data, geolocation data, and endpoint device usage patterns;
determine, using the second machine learning model, a presence or an absence of at least one malfeasance indicator by determining at least one malfeasance score based on the interaction data and comparing the at least one malfeasance score with predetermined malfeasance indicator thresholds; and
generate a digital twin of the user using the interaction data, wherein the digital twin generates simulated user activities via a digital representation.

9. The computer program product of claim 8, wherein the code further causes the apparatus to:
record, in a distributed ledger, the presence or absence of the at least one malfeasance indicator.

10. The computer program product of claim 8, wherein the digital twin comprises:
a data integration module operatively coupled to real-time data sources, the real-time data sources comprising resource transfer gateways, the data integration module continuously updating the digital representation with the real-time data sources;
a predictive analytics engine configured to generate the simulated user activities based on historical and real-time data; and
an onboarding criteria adjustment module, operatively coupled to the predictive analytics engine, configured to dynamically recalibrate the predetermined malfeasance indicator thresholds in response to the simulated user activities.

11. The computer program product of claim 8, wherein the task workflow comprises critical dates for the onboarding tasks, and wherein the code further causes the apparatus to:
monitor the completion of the onboarding tasks relative the critical dates; and
generate an alert signal upon a first condition where at least one onboarding task is not completed relative a corresponding critical date.

12. The computer program product of claim 8, wherein the onboarding data is at least one selected from the group consisting of user identification data, user ledger data, and compliance data.

13. The computer program product of claim 8, wherein onboarding tasks are at least one selected from the group consisting of document submission, compliance verification, and identity verification.

14. The computer program product of claim 8, wherein the first machine learning model and the second machine learning model are the same machine learning model.

15. A method for data synchronization and data onboarding protocol using digital twins in a distributed network, the method comprising:
receiving onboarding data for a user, wherein the onboarding data is received through an API or web-based interface;
identifying, based on the onboarding data and using a first machine learning model comprising natural language processing, onboarding tasks;
generating, using the first machine learning model, a task workflow of the onboarding tasks;
receiving a stream of task completion data for the onboarding tasks of the task workflow;
logging completion of the onboarding tasks in the task workflow;
receiving, in a second machine learning model, a stream of interaction data of the user, wherein the interaction data is at least one selected from the group consisting of resource transfer data, geolocation data, and endpoint device usage patterns;
determining, using the second machine learning model, a presence or an absence of at least one malfeasance indicator by determining at least one malfeasance score based on the interaction data and comparing the at least one malfeasance score with predetermined malfeasance indicator thresholds; and
generating a digital twin of the user using the interaction data, wherein the digital twin generates simulated user activities via a digital representation.

16. The method of claim 15, wherein the method further comprises:
recording, in a distributed ledger, the presence or absence of the at least one malfeasance indicator.

17. The method of claim 15, wherein the digital twin comprises:
a data integration module operatively coupled to real-time data sources, the real-time data sources comprising resource transfer gateways, the data integration module continuously updating the digital representation with the real-time data sources;
a predictive analytics engine configured to generate the simulated user activities based on historical and real-time data; and
an onboarding criteria adjustment module, operatively coupled to the predictive analytics engine, configured to dynamically recalibrate the predetermined malfeasance indicator thresholds in response to the simulated user activities.

18. The method of claim 15, wherein the task workflow comprises critical dates for the onboarding tasks, and wherein the method further comprises:
monitoring the completion of the onboarding tasks relative the critical dates; and
generating an alert signal upon a first condition where at least one onboarding task is not completed relative a corresponding critical date.

19. The method of claim 15, wherein the onboarding data is at least one selected from the group consisting of user identification data, user ledger data, and compliance data.

20. The method of claim 15, wherein onboarding tasks are at least one selected from the group consisting of document submission, compliance verification, and identity verification.
